(19) United States
(12) Patent Application Publication
(10) Pub. No.: US 2004/0192414 A1
(43) Pub. Date: Sep. 30, 2004

(54) Telephone remote

(76) Inventors: James A. Moore, Maple Hts., OH (US); Brenda L. Moore, Maple Hts., OH (US)

Correspondence Address: JAMES/ BRENDA MOORE, 19276 STAFFORD AVE., MAPLE HTS., OH, 44137, US

(21) Appl. No.: 10/195,028

(22) Filed: Mar. 27, 2003

(51) Int. Cl. H04M 1/00

(52) U.S. Cl. 455/575.1

(57) ABSTRACT

The Telephone Remote is a device that can control electronic devices. This unit will allow you to use one device to control the telephone, television, and has a tracking system.

The tracking system allows you to track someone's movement and offers a video picture. The unit is also equipped with a indicator light for the hearing impaired. You can also access the last call which is indicated with an indicator light as well. This unit is completely wireless. This global tracking system is for locating an object. Each tracking device includes a processing device for storing an identification code. To track a device determine a location of the tracking device generating a position signal based upon determine the location. Each cellular transmission compares the identification code with its stored identification code. The tracking unit stores the identification code and determine the match and receive the identification code and generates the transmits the signal to the central monitoring station cellular transmission channels. The central monitoring station relays the position signal to the user. The user is able to provide a location request to the central monitoring station by one of the telephone communication.

### SUMMARY OF THE INVENTION

The all over of the product is to operate this wireless telephone remote for a telephone or a remote to control the television and a tracking system. You can hit the telephone indicator for the keys to operate as a phone. The light indicator will light up when the impaired people are in use of the telephone remote. If you hit the remote indicator the keys will operate for the television or hit the tracking system to track the location of a person and display a picture of the person if the next person have their telephone remote tracking system on. If the next person insist on their privacy then they won't need the tracking system on. We do respect your privacy. This product is great for the safety of your children.

### DESCRIPTION OF DRAWINGS

FIG. 1. Front view of Telephone Remote Control.

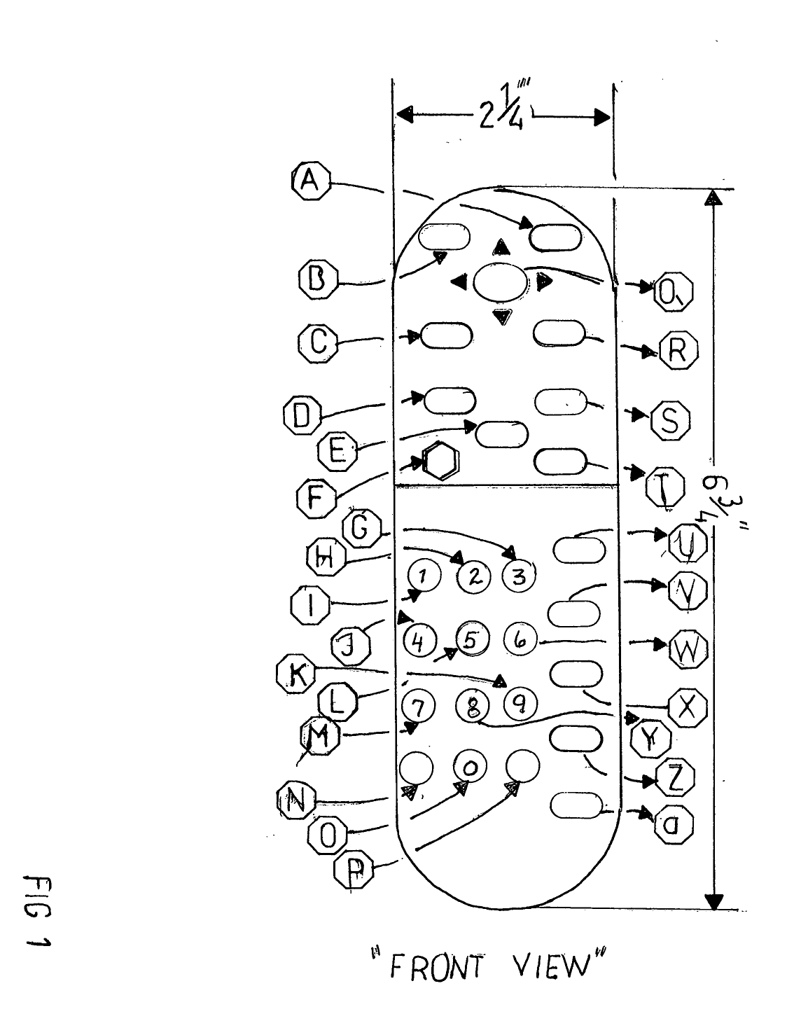

FIG. 2. Back view of Telephone Remote Control.

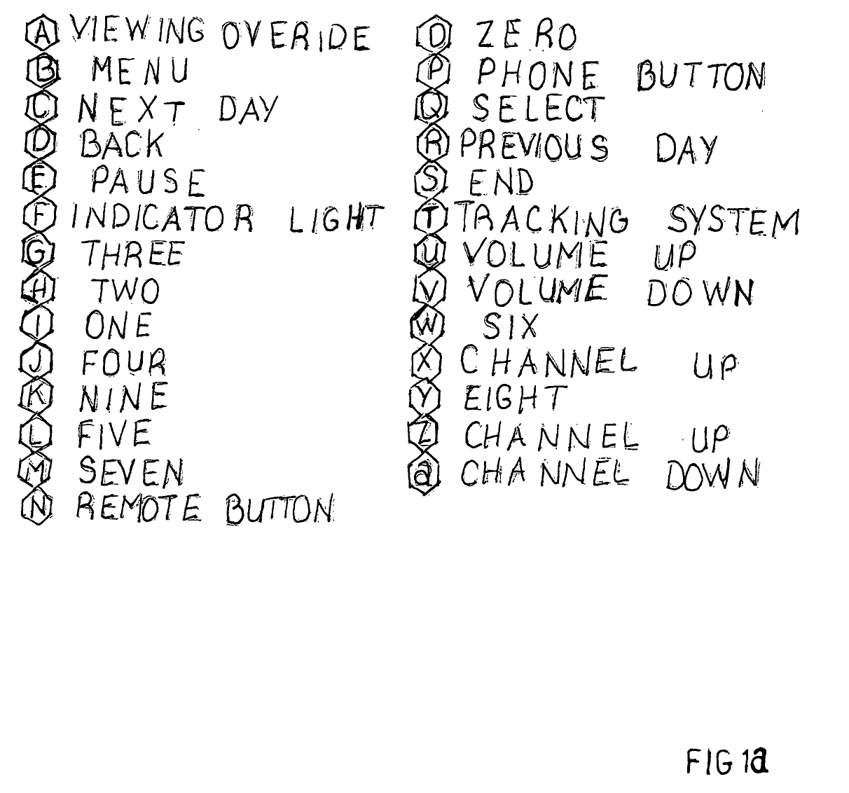

FIG. 3. Side view of Telephone Remote Control.

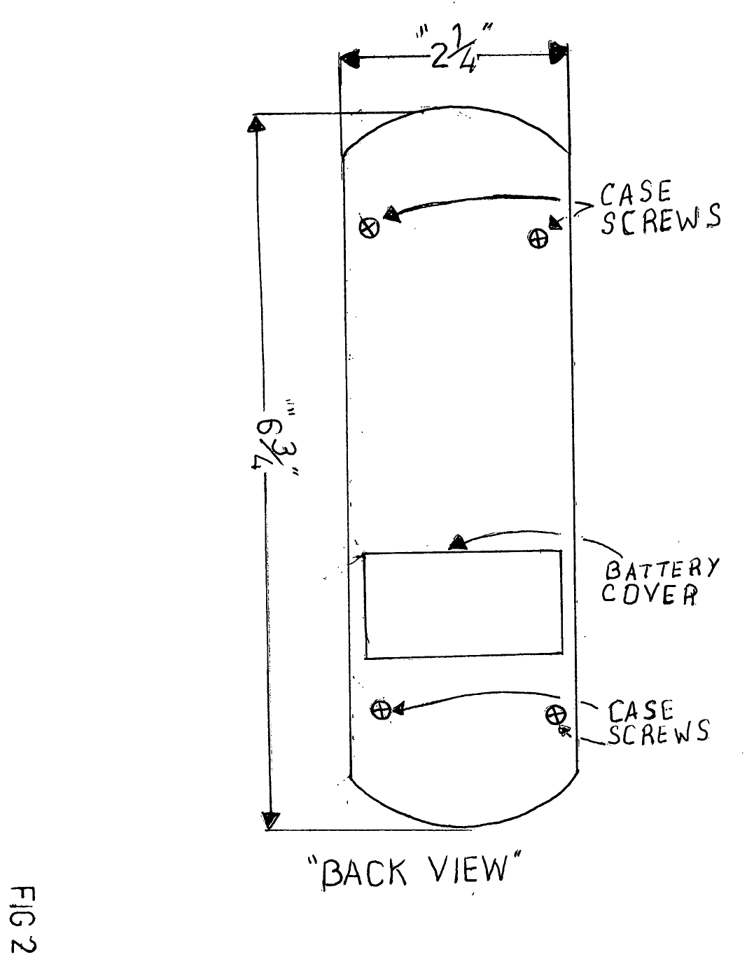

FIG. 4. Front view of Telephone Remote Control Base Unit.

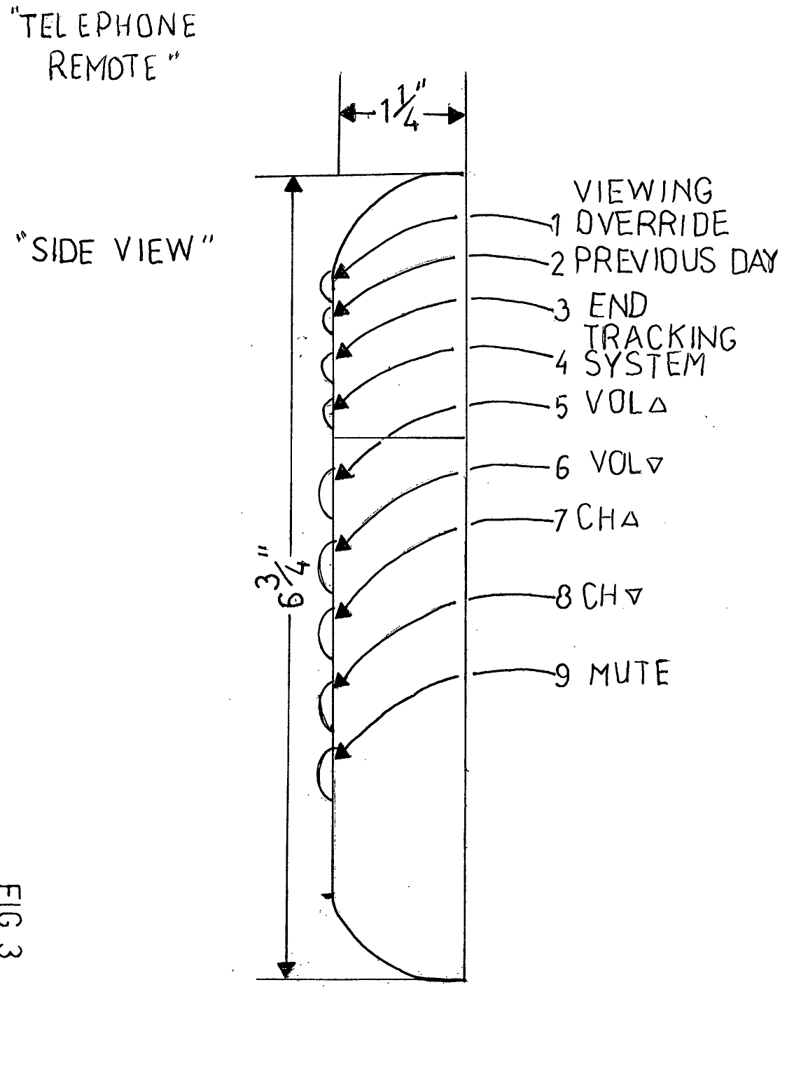

FIG. 5. A dimensional view of Telephone Remote Control Base Unit.

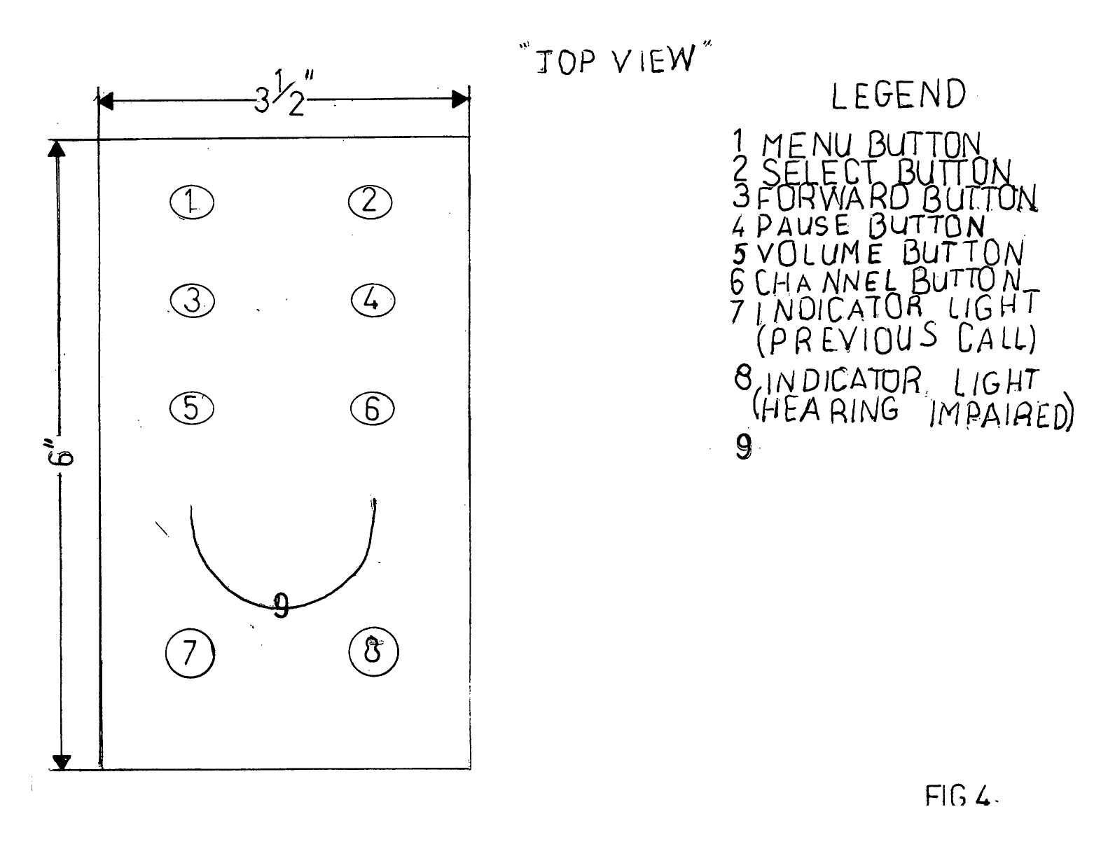

FIG. 6. Reference page for FIG. 1 Touch Pad Buttons

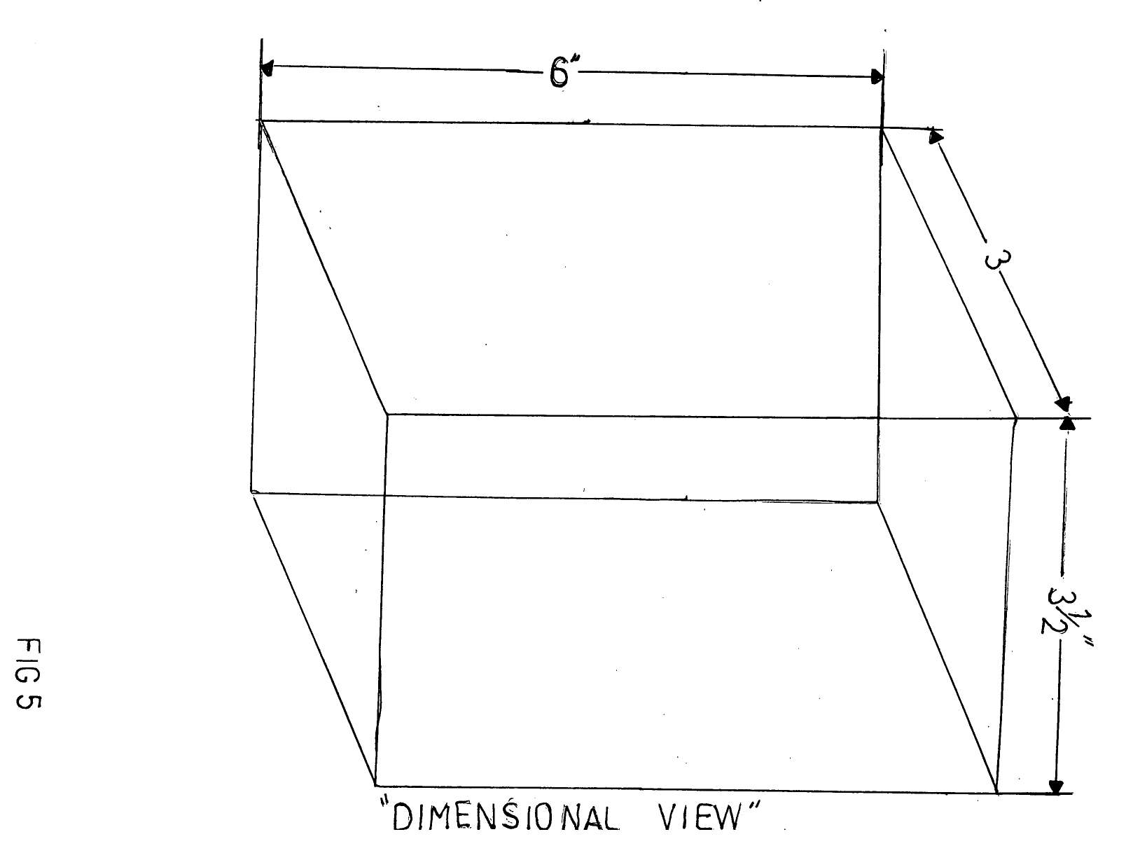

1. This Telephone Remote has multiple transmitter functions.

2. This wireless Telephone Remote will operate your phone at the same time you're Operating your television system in response to said key signals imputed by said key inputting.

3. Tracking system can locate the area and display the picture of a person.

4. This product will display a person picture.

5. Product will control the over all features to your phone and television.

6. The base unit is wireless device that include the sound and data transceiver.

7. This product has a cover receiver.

8. A menu button to control:
a. SETUP MEMU
b. AUDIO MENU
c. PIP MENU
d. SOURCE MENU
e. VIDEO MENU

9. Select button and button that indicate calls that came in the previous day.

10. Forward to the next message.

11. The telephone remote also has a pause feature.

12. The volume feature can indicate up and down feature.

13. Channel change button can change to whatever channel of your choice.

14. This telephone remote consist of a light indicator that can be use by impaired people.

15. The light indicator is indicate on the first of the product.
